(19) United States
(12) Patent Application Publication
(10) Pub. No.: US 2022/0065815 A1
(43) Pub. Date: Mar. 3, 2022

(54) FLUID IDENTIFICATION VIA ELECTROCHEMICAL LABELS

(71) Applicant: Hewlett-Packard Development Company, L.P., Spring, TX (US)

(72) Inventors: Tod Woodford, Corvallis, OR (US); Alexander Govyadinov, Corvallis, OR (US); Brian J. Keefe, San Diego, CA (US); Diane R. Hammerstad, Corvallis, OR (US)

(73) Assignee: Hewlett-Packard Development Company, L.P., Spring, TX (US)

(21) Appl. No.: 17/415,388

(22) PCT Filed: May 7, 2019
(86) PCT No.: PCT/US2019/031029

§ 371 Date: Jun. 17, 2021

(51) Int. Cl. G01N 27/49; G01N 27/327; B01L 3/00

(52) U.S. Cl. CPC G01N 27/49; G01N 27/3277; B01L 3/502715; B01L 2400/0415; B01L 2300/0645; B01L 2300/0816; B01L 2300/0636

(57) ABSTRACT

In one example in accordance with the present disclosure, a fluid analysis device is described. The fluid analysis device includes a chamber to receive a number of fluids. At least one fluid includes an electrochemical label with a unique electrochemical response to an applied electrical potential. A multi-electrode sensor of the fluid analysis device is disposed within the chamber and detects electrical signals within the chamber. The fluid analysis device also includes a controller coupled to the multi-electrode sensor. The controller applies an electrical potential across multiple electrodes of the multi-electrode sensor and identifies, from the electrical signal detected by the multi-electrode sensor, fluids currently in the chamber based on the unique electrochemical responses of associated electrochemical labels.

### BACKGROUND

Analytic chemistry is a field of chemistry that uses instruments to separate, identify, and quantify matter. In analytic chemistry, the fluid to be analyzed, or components there in are measured, chemically processed, and/or physically manipulated.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a fluid analysis device for fluid identification via electrochemical labels, according to an example of the principles described herein.

FIG. 2 is a block diagram of a fluid analysis system for fluid identification via electrochemical labels, according to an example of principles described herein.

FIG. 3 is a diagram of a fluid analysis system for fluid identification via electrochemical labels, according to an example of principles described herein.

FIG. 4 is a flow chart of a method for fluid identification via electrochemical labels, according to an example of the principles described herein.

FIG. 5 is a diagram of a controller and multi-electrode sensor for fluid identification via electrochemical labels, according to an example of the principles described herein.

FIG. 6 is a graph depicting electrochemical responses for fluid identification via electrochemical labels, according to an example of the principles described herein.

FIG. 7 is a flow chart of a method for fluid identification via electrochemical labels, according to another example of the principles described herein.

FIGS. 8A-8C depict various multi-sensor electrode for fluid identification, according to an example of the principles described herein.

FIGS. 9A and 9B are diagrams of a fluid analysis device for fluid identification via electrochemical labels, according to an example of the principles described herein.

FIG. 10 is a diagram of a fluid analysis system for fluid identification via electrochemical labels, according to another example of principles described herein.

FIG. 11 is a diagram of a fluid analysis system device for fluid identification via electrochemical labels, according to another example of principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Analytic chemistry is a field of chemistry that uses instruments to separate, identify, and quantify matter. In analytic chemistry, the fluid to be analyzed, or components there in are measured, chemically processed, and/or physically manipulated.

Such fluid analysis is performed in a chamber where fluid is received. A fluid analysis device may be used to perform fluid analysis on a variety of different fluids. That is, at different points in time different fluids may be introduced into a chamber for analysis. In another example, during a single analysis operation, one or several fluids may flow through the chamber in a specific sequence. In some examples, the different fluids may be incompatible, meaning different fluids may react with one another in an undesirable way that may affect the fluid analysis. Accordingly, if fluids are not sufficiently flushed out of the chamber, cross-contamination of fluids may occur which may inhibit the desired reaction and may skew any analysis output resulting therefrom. This insufficient flushing may ultimately result in a test failure. If the presence of the fluid that was supposed to have been flushed is not detectable, the cause of the failure may not be detectable.

Accordingly, the present specification describes a device and method that allow for a determination as to which fluids are in the chamber. This information can be used in a variety of ways. For example, to ensure that a first fluid has been fully removed prior to a subsequent fluid being introduced so as to avoid such cross-contamination. As another example, it may be desirable to mix fluids to carry out any number of chemical reactions. In many cases, such reactions rely on precise quantities of each fluid being presented.

Accordingly, the present specification involves the use of electrochemical sensors. The electrochemical sensors may be used to determine whether, and in what quantities, a particular fluid is present in a chamber. As a specific example, the electrochemical sensors can detect when one solution has been removed from a chamber. Accordingly, these sensors can prevent cross-contamination, and in the event cross-contamination does occur, can indicate the cause of the contamination. In the example of fluid mixing, the electrochemical sensors also ensure that appropriate quantities of different fluids have been added during admixture of those fluids.

That is, the present specification describes a fluid analysis device for detecting the presence of specific fluids such as lysing agents, washing fluids, elution agents, and polymerase chain reaction (PCR) master mix in a chamber by using different electrochemical labels for different fluids. The fluid and electrochemical labels are selected based on a neutrality (non-inhibition) to biochemical reactions that occur in the chamber. The fluid analysis device includes a multi-electrode sensor in the chamber. The fluid analysis device also includes a controller which may include a potentiostat connected to the multi-electrode sensors. The controller may control and interpret the electrode potentials in order to determine which fluids are present, their concentrations, and to control the subsequent flow of remaining fluids. The fluid analysis device is part of a larger fluid analysis system that includes fluid sources, and different electrochemical compounds to differentiate fluids.

In one example, the fluid analysis device includes one electrochemical label to detect one specific fluid. However, in other examples, the fluid analysis device includes multiple electrochemical labels, corresponding to different fluids. Other versions of the fluid analysis device may use just two types of electrochemical labels altering them for sequentially added fluids or mixing in the chamber.

Specifically, the present specification describes a fluid analysis device. The fluid analysis device includes a chamber to receive a number of fluids. At least one fluid includes an electrochemical label with a unique electrochemical response to an applied electrical potential. A multi-electrode sensor is disposed within the chamber to detect electrical signals within the chamber. The fluid analysis device also includes a controller coupled to the multi-electrode sensor. The controller 1) applies an electrical potential across multiple electrodes of the multi-electrode sensor and 2) identifies, from the electrical signals detected by the multi-electrode sensor, fluids currently in the chamber based on the unique electrochemical responses of associated electrochemical labels.

The present specification also describes a fluid analysis system. The system includes a number of reservoirs. Each reservoir holds 1) a volume of a redox label having a unique electrochemical response to an applied electrical potential and 2) a volume of fluid to be used in a chamber. The fluid analysis system also includes a number of chambers to receive a mixture of the fluid and an associated redox label. A multi-electrode sensor disposed within each chamber detects an electrical signal within the chamber. The fluid analysis system also includes a controller coupled to the multi-electrode sensors. The controller 1) applies an electrical potential across multiple electrodes of the multi-electrode sensor; 2) identifies, from an electrical signal detected by the multi-electrode sensor, fluids currently in the chamber based on the unique electrochemical responses of associated redox labels; and 3) measures, from a current detected by the multi-electrode sensor, a concentration of fluids currently in the chamber based on the electrochemical responses of associated redox labels.

The present specification also describes a method. According to the method, a tagged fluid is introduced into a chamber with a multi-electrode sensor. An electrical signal is measured across multiple electrodes of the multi-electrode sensor. Based on a measured electrical signal, fluids currently in the chamber are identified based on the unique electrochemical responses of associated electrochemical labels. At least one component (such as a pump or a valve) of a fluid analysis system is selectively activated based on an identified fluid. The at least one component is coupled to the chamber.

The systems and methods of the present specification 1) provide reliable detection of specific fluids by tagging each with a different electrochemical label which enables fluid traceability; 2) provides information regarding the cleansing of a fluid from the chamber; 3) increases speed of test and cleansing reliability by stopping a cleansing operation when a fluid is no longer detected; 4) provides an indication of a potential source of test failure; 5) prevents cross contamination and undesired mixing of fluids in a chamber; 6) provides feedback as to the concentration of specific fluids in a chamber; 7) provides data regarding combination of different fluids such that sufficient mixing may be determined; 8) provides precise control over which fluid is in the chamber; 9) enables automatic control of fluid delivery; 10) reduces human or system error which may produce undesired fluid delivery and/or cross-contamination; 11) enables efficient use of valuable fluids; and 12) miniaturizes electrochemical monitoring.

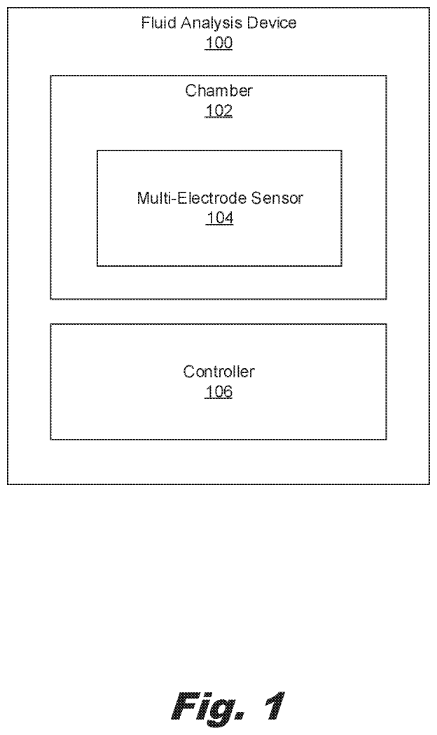

Turning now to the figures, FIG. 1 is a block diagram of a fluid analysis device (100) for fluid identification via electrochemical labels, according to an example of the principles described herein. In some examples, the fluid analysis device (100) is a microfluidic structure. In other words, the components, i.e., the chamber (102) and an associated multi-electrode sensor (104) may be microfluidic structures. A microfluidic structure is a structure of sufficiently small size (e.g., of nanometer sized scale, micrometer sized scale, millimeter sized scale, etc.) to facilitate conveyance of small volumes of fluid (e.g., picoliter scale, nanoliter scale, microliter scale, milliliter scale, etc.).

The fluid analysis device (100) includes a chamber (102) to receive a number of fluids. The fluids may be received sequentially or in parallel. That is, the chamber (102) may include one input port to receive an input fluid or may include multiple input ports to receive multiple input fluids. As described above, the chamber (102) may be a microfluidic chamber (102). For example, the chamber (102) may hold less than 10 microliters of fluid at any point in time.

At least one fluid may be tagged with an electrochemical label with a unique electrical response to an applied electrical potential. As a specific example, an electrochemical label may be a reduction-oxidation label, also referred to as a redox label. A redox label is a compound that can repeatedly lose or gain electrons at specific electrical potentials of the electrode. The redox label potential is a measure of the ease with which a label (molecule) will accept electrons. That is, when an electrical potential is applied to an electrode exposed to solution in which the redox label is found, the redox label loses or gains an electron which can be measured electrically. The electrical potential at which such an electron transfer occurs and the resulting conductivity of the solution define the electrochemical response of the redox label, and such a response differs between redox labels. Such an operation is performed in the chamber (102) by a controller (106) and multi-electrode sensor (104). That is, the controller (106) which is coupled to the multi-electrode sensor (104) applies an electrical potential across multiple electrodes of the multi-electrode sensor (106) which causes the loss of the electron from the redox label. The result of the loss of the electron is a current that can be measured. The value of the current, and the electrical potential at which the redox reaction occurs is referred to as the electrochemical response of the redox reaction and can be used to identify the redox label presence and concentration.

The identification of a particular electrochemical label thereby also allows for identification of any fluid that is uniquely associated with that particular electrochemical label. That is, fluids may be tagged with an electrochemical label that has a unique electrochemical response to an applied electrical potential. A controller (106) of the fluid analysis device (100) applies an electrical potential across multiple electrodes of the multi-electrode sensor (104). The multi-electrode sensor (104), which is disposed within the chamber (102), then detects electrical signals within the chamber (102), and the controller (106) can identify, from the detected electrical signals, which fluids are currently in the chamber (102) based on the unique electrochemical responses of associated electrochemical labels. That is, the controller (106) may include a potentiostat that applies a changing voltage to two of the electrodes while monitoring the current which flows between them. That is, as each redox label increases in conductivity based on different applied electrical potentials, each also has a distinct electrochemical response. The magnitude of each redox signal is proportional to the concentration of the redox label in the total solution. Accordingly, the controller (106) determines, based on a current value within the chamber and the electrochemical responses of associated electrochemical labels, a concentration of fluids currently in the chamber. Accordingly, based on a detected magnitude of current at a particular applied electrical potential, the controller (106) can identify which electrochemical label is present and in what quantities.

In other words, the fluid analysis device (100) in general allows fora determination of fluids present in a chamber (102) based on the detected electrochemical responses of electrochemical labels associated with those fluids. Such detection may be used to either ensure proper isolation of sequential fluids in a fluid analysis operation, or to ensure proper combination of fluids to be mixed.

Specifically, the present fluid analysis device (100) includes a microscale multi-electrode sensor (106) within a microfluidic system. Fluids passed to the microfluidic chamber (102) are tagged with redox labels or other electrochemical labels. Such a fluid analysis device (100) allows for the monitoring of which fluid is present over the multi-electrode sensor (104) as well as its concentration. This can be used by a controller (106) to determine when one fluid has been in the chamber (102) for a sufficient amount of time, when it has been removed, and when to introduce a subsequent fluid.

The proposed fluid analysis device (100) can detect the presence of specific fluids. For example, in chemical reactions, fluids such as lysing agents, washing fluids, elution agents, and PCR master mix may be introduced simultaneously or sequentially. If simultaneously, i.e., fluids to be mixed, the fluid analysis device (100) can be used to determine an appropriate ratio of those fluids to be mixed. If sequentially, the fluid analysis device (100) can be used to determine when one fluid is absent such that a subsequent fluid can be added without risk of cross-contamination.

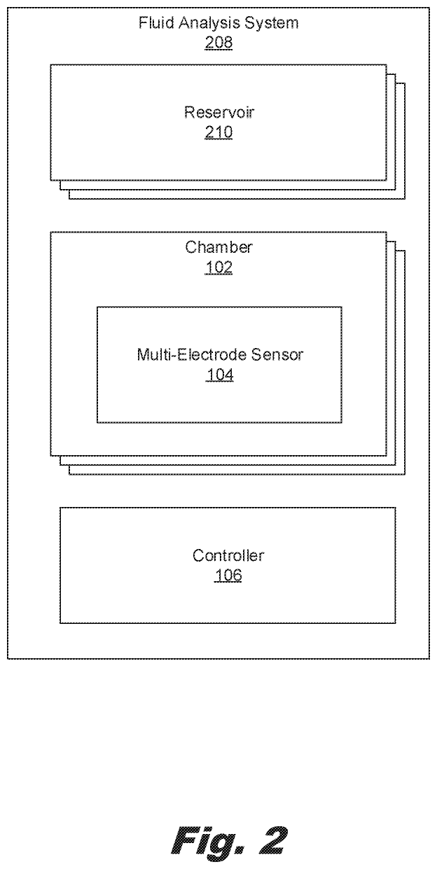

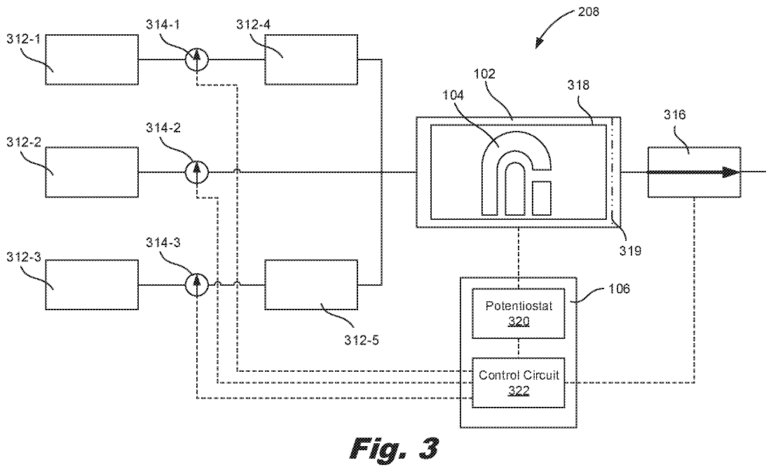

FIG. 2 is a block diagram of a fluid analysis system (208) for fluid identification via electrochemical labels, according to an example of principles described herein. In this example, the fluid analysis system (208) includes a number of reservoirs (210). Each reservoir (210) is to hold a volume of a redox label having a unique electrochemical response to an applied electrical potential and a volume of a fluid to be used in a chamber (FIG. 1, 102). In some examples, the fluid and associated redox labels may be pre-mixed in the reservoir (210). That is, a reservoir (210) may include a pre-mixed solution of fluid and an associated redox label. In another example, as depicted in FIG. 3 each reservoir (210) may initially separate the two. That is, a first sub-reservoir may include a solution including the redox label which may be fed to another sub-reservoir that includes the fluid to be used in the chamber (FIG. 1, 102). In this second sub-reservoir, or along the path from the second sub-reservoir to the chamber (102) the fluid is mixed with the redox label.

As described above, the fluid analysis system (208) may include any number of reservoirs (210) including one or multiple. Multiple reservoirs (210) may hold different fluid/redox label mixtures to perform different operations.

In either case, the fluid analysis system includes any number of chambers (102) to receive a mixture of a fluid to be used in the chamber (102) and an associated redox label. The multi-electrode sensor (104) disposed within a respective chamber (102) detects an electrical signal within the chamber (102) as described above.

The controller (106) applies an electrical potential across multiple electrodes of the multi-electrode sensor (104) and identifies, from an electrical signal detected by the multi-electrode sensor (104), fluids currently in the chamber (102) based on the unique electrochemical responses of associated redox labels. Additionally, as described above, the controller (106) may also measure a concentration of the fluids in the chamber (102) based on a current detected by the multi-electrode sensor (104) and electrochemical responses of associated redox labels.

FIG. 3 is a diagram of a fluid analysis system (208) for fluid identification via electrochemical labels, according to an example of principles described herein. In FIG. 3, fluid paths are depicted in solid lines and control paths are depicted in dashed lines. As described above, in some examples, the fluid analysis system (208) includes reservoirs (FIG. 2, 210) that hold fluid to be used in the chamber (102) as well as redox labels. In the example depicted in FIG. 3, the reservoirs (FIG. 2, 210) include multiple sub-reservoirs (312) that hold different contents. For example, some sub-reservoirs (312-1, 312-2, 312-3) are sub-reservoirs that include solutions tagged with different redox labels. These compounds are delivered to other sub-reservoirs (312-4, 312-5) or the chamber (102) based on the opening of respective valves (314) that otherwise prevent such flow. Each fluid, again based on the operation of the valves (314) and a fluid pump (316), is selectively introduced into the chamber (102) where a chemical reaction occurs and where the presence of different fluids is detected via the multi-electrode sensor (104).

A specific example of the operation of the fluid analysis system (208) is now provided. In this example, a first redox label in the first sub-reservoir (312-1) is not compatible with a third redox label in the third sub-reservoir (312-3) and therefore are to be prevented from mixing. In this example, a user may input a sample to be tested in the fourth sub-reservoir (312-4). The control circuit (322) of the controller (106) opens a first valve (314-1) and also turns on the fluid pump (316) drawing the first redox label and the sample fluid into the chamber (102). The multi-electrode sensor (104) and the potentiostat (320) verify the presence of the first redox label. Responsive to this detection, the control circuit (322) stops the fluid pump (316) and closes the first valve (314-1) trapping the sample fluid in the chamber (102).

After a period of time it may be desired to wash the sample from the chamber (102). Accordingly, after an incubation period, the control circuit (322) opens the second valve (314-2) and turns on the fluid pump (316) to flush out the sample fluid/first redox label and to pull the second redox label into the chamber (102) from the second sub-reservoir (312-2). Initially, the multi-electrode sensor (104) and potentiostat (320) may detect the presence of the first redox label and the second redox label and may continue to operate the fluid pump (316) until the first redox label is no longer detected. Accordingly, the sample fluid has now been flushed out by the second redox label. Thus, the controller (106) may selectively activate a fluid pump (316) to draw fluid out of the chamber (102) until it is detected that less than a threshold quantity of the fluid remains in the chamber (102).

In some examples, it may be desirable to flush a solution including the sample, but keeping the sample in the chamber (102). For example, a solution including DNA may be introduced into the chamber (102) and the solution may be flushed, but the DNA may remain in the chamber (102). In this example, the chamber (102) may include a filter (319) to retain the component.

After an incubation period, the controller (106) initializes another fluid analysis operation. Accordingly, the control circuit (322) opens the third valve (314-3) and turns on the fluid pump (316) to pull the third redox label in the third sub-reservoir (312-3) through a lyophilized reagent in the fifth sub-reservoir (312-5), which is reconstituted and carried into the chamber (102). This also flushes out the second redox label from the chamber (102). The multi-electrode sensor (104) and potentiostat (320) then detect the presence and concentrations of the second redox label and the third redox label and continues the flushing operation until the second redox label is no longer detected. The control circuit (322) may then close the third valve (314-3), turn off the fluid pump (316), and turn on a heater (318) to initiate a biological process.

A similar operation may be performed to detect appropriate mixture levels for specific reactions to take place. That is, the controller (106) may selectively activate a number of valves (314) to draw quantities of a first fluid (i.e., the sample fluid) and a second fluid (i.e., the lyophilized reagent) into the chamber (102) until a predetermined ratio of the first fluid and the second fluid is detected in the chamber (102) based on unique electrochemical responses of electrochemical labels associated, or tagged onto, the first fluid and second fluid.

In other words, as described above, the controller (106) selectively activates at least one component based on identified fluids. As depicted in FIG. 3, examples of these components include valves (314) to allow fluid to flow into the chamber (102) and pumps (316) to draw fluid through chamber (102).

Thus, the present fluid analysis system (208) and fluid analysis device (FIG. 1, 100) allow for increased efficiency in fluid analysis operations by providing a closed-loop fluid control. That is, rather than blindly cleaning a chamber (102) for a predetermined time without knowing whether a sample has or has not been flushed, data specifically collected from the chamber (102) may be used to determine whether a chamber (102) has been sufficiently cleaned.

For example, in some cases a cleansing fluid may be run through the chamber (102) for a predetermined amount of time without any indication of whether it has appropriately flushed the chamber (102) of a first fluid. This predetermined amount of time may be more than is needed to cleanse the chamber (102) or may not be enough such that residual first fluid is still in the chamber (102).

By using data collected from within the chamber (102), the controller (106) may determine that the chamber (102) is cleaned before the predetermined amount of time expires and may thus end the cleaning operation earlier and continue with subsequent fluid analysis operations at an earlier point in time.

In another example, the chamber (102) may not be sufficiently cleaned due to not flushing the chamber (102) for sufficient periods of time to cleanse it of a first fluid. Accordingly, subsequent fluid analysis operations may be contaminated by residues of the first fluid. In this example, data collected from within the chamber (102) may justify running more cleaning fluid through the chamber (102) so as to ensure proper cleaning and thus protect against any undesired cross-contamination. In other words, the present fluid analysis system (208) provides a closed-loop control over fluid transport through the system which provides greater reliability of test results and more efficient use of reagents in fluidic testing.

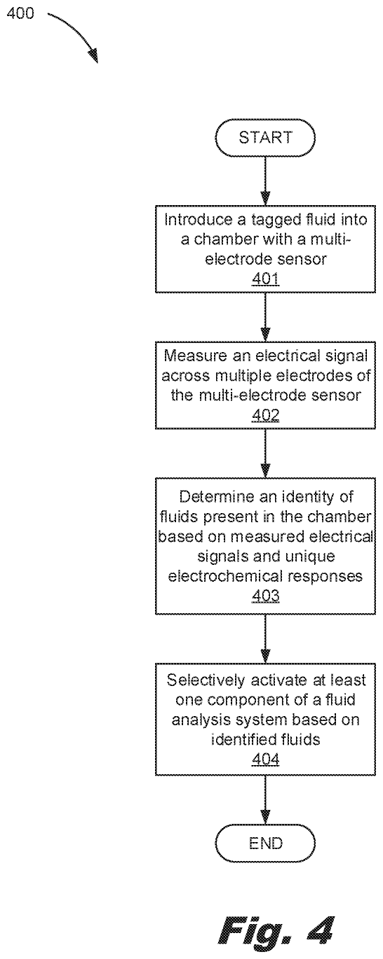

FIG. 4 is a flow chart of a method (400) for fluid identification via electrochemical labels, according to an example of the principles described herein. According to the method (400), a tagged fluid is introduced (block 401) into a chamber (FIG. 1, 102) where a reaction is to occur. That is, fluid to be used in a microfluidic chamber (FIG. 1, 102) is tagged with an electrochemical label. The fluid may be of any types including a sample to be analyzed, lysing agents, washing fluids, elution agents, and polymerase chain reaction (PCR) master mix. In some examples, the tagging of the fluid may occur in a reservoir (FIG. 2, 210) or may occur along a path between sub-reservoirs (FIG. 3, 312) as depicted in FIG. 3. In yet another example, the tagging may be done prior to introduction into the fluid analysis system (FIG. 2, 208). In either case, as described above, each electrochemical label may have a unique electrochemical response to an applied electrical potential.

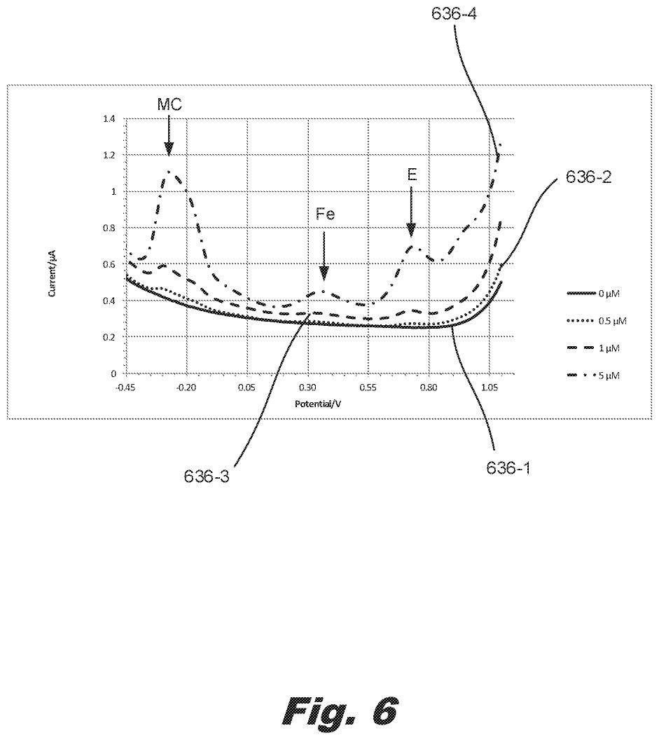

Disposed within the chamber (FIG. 1, 102) is a multi-electrode sensor (FIG. 1, 104) that, along with a controller (FIG. 1, 106), is used to determine which fluid is present within the chamber (FIG. 1, 102) and in what concentration. Accordingly, the controller (FIG. 1, 106) applies an electrical potential across multiple electrodes of the multi-electrode sensor (FIG. 1, 106), and the multi-electrode sensor (FIG. 1, 104) measures (block 402) an electrical signal across multiple electrodes of the multi-electrode sensor (FIG. 1, 106). The electrical signal includes a current response to an applied electrical potential. FIG. 6 provides examples of various electrical responses of different redox labels.

Based on unique electrochemical responses of associated electrochemical labels, the controller (FIG. 1, 106) determines (block 403) an identify of fluids present in the chamber (FIG. 1, 102) from the electrical signals. That is, the controller (FIG. 1, 106) having applied an electrical potential, detecting a redox reaction at a particular electrical potential, and receiving a detected current, can determine what electrochemical label is detected, and from that can identify the fluid that has been tagged with that particular electrochemical label.

Based on an identified fluid, the controller (FIG. 1, 106) selectively activates (block 405) at least one component of the fluid analysis system (FIG. 2, 208). As described above, such components include valves that couple reservoirs (FIG. 2, 210) to the chamber (FIG. 1, 102) and fluid pumps (FIG. 3, 316) that draw fluid through the chamber (FIG. 1, 102). Thus, the method (400) as described herein provides for data-based fluid control as opposed to fluid control based on estimates.

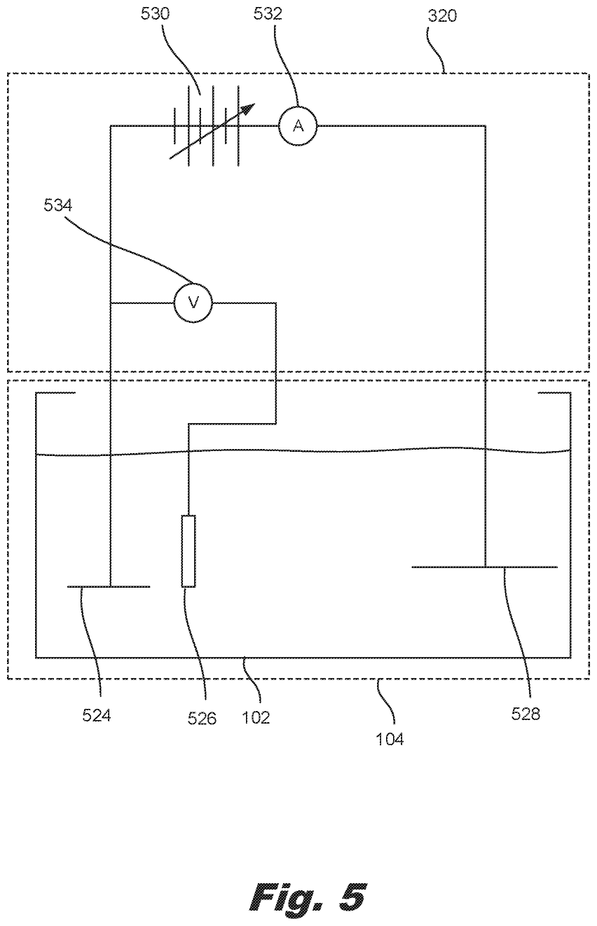

FIG. 5 is a diagram of a controller (FIG. 1, 106) and multi-electrode sensor (104) for fluid identification via electrochemical labels, according to an example of the principles described herein. More specifically, FIG. 5 depicts the potentiostat (320) and the multi-electrode sensor (104). In some examples, the multi-electrode sensor (104) may be a tri-electrode sensor (104) with a working electrode (524), a reference electrode (526), and a counter electrode (528). The potentiostat (320) applies a voltage on the working electrode (524) and counter electrode (528) and measures a potential between the working electrode (524) and the reference electrode (526). In a specific example, the controller (FIG. 1, 106) calls for an electrical potential of 0.5 V. Accordingly, a variable voltage source (530) applies a voltage to the working electrode (524) and the counter electrode (528) until the electrical potential read at the voltmeter (534) is 0.5 V. Note that the voltage source (530) may be applying a larger potential between the counter electrode (528) and the working electrode (524) to achieve this. For example, the voltage source (530) may apply an electrical potential of 0.9 V between the working electrode (524) and the counter electrode (528) to achieve the 0.5 V between the working electrode (524) and the reference electrode (526).

Once the desired electrical potential between the working electrode (524) and the reference electrode (526) is reached as measured by the voltmeter (524), a current is measured by the ammeter (532). Accordingly, in this fashion, the voltage is swept across a range while the current is measured.

That is, the potentiostat (320) monitors current between the working electrode (524) and the counter electrode (528), which current is indicative of a quantity of the redox labels in the chamber (102). The potentiostat (320) also measures an electrical potential between the working electrode (524) and the reference electrode (526). Different applied electrical potentials trigger redox reactions in different redox labels. Accordingly, by knowing the applied electrical potential at which the electrochemical reaction (redox) occurs and detecting a current spike, the potentiostat (320) aids the controller (FIG. 1, 106) in determining fluid presence and concentration.

FIG. 6 is a graph depicting an output for fluid identification via electrochemical labels, according to an example of the principles described herein. That is, FIG. 6 depicts electrochemical responses for three different redox labels. The redox labels indicated in FIG. 6 are methylthioninium chloride having a chemical formula of C₁₆H₁₈ClN₃S, ferrocene having a chemical formula of C₁₀H₁₀Fe, and an erythrosine-based compound having the chemical formula C₂₀H₆I₄Na₂O₅.

As described above, each redox label is activated at a different applied potential and results in a different current value based on its concentration. These two values make up the compound electrochemical response and can be used to identify an electrochemical label and associated fluid within a chamber (FIG. 1, 102). The different lines in FIG. 6 indicate different concentrations of the respective redox labels. For example, a first line (636-1) corresponds to 0 micro moles of the redox labels, a second line (636-2) corresponds to 0.5 micro moles, a third line (636-3) corresponds to 1 micro mole, and a fourth line (636-4) corresponds to 5 micro moles per liter concentration.

During use, the multi-electrode sensor (FIG. 1, 104) may apply an increasing electrical potential between the working electrode (FIG. 5, 524) and the counter electrode (FIG. 5, 528). When the electrical potential between the working electrode (FIG. 5, 524) and the reference electrode (FIG. 5, 526) is approximately −0.26, the potentiostat (FIG. 3, 320) may detect a current value. As seen by the graph this electrochemical response, i.e., detected current at a particular electrical potential, is indicative of the methylthioninium chloride (MC) redox label, which would be associated with a particular fluid such that the controller (FIG. 1, 106) could determine that the fluid is present in the chamber (FIG. 1, 102). The value of the current may indicate the concentration. For example, when the electrical potential between the working electrode (FIG. 5, 524) and the reference electrode (FIG. 5, 526) is −0.26 V, the potentiostat (FIG. 3, 320) may indicate a current value of approximately 1.10 micro amperes. This would indicate a concentration of 5 micro moles of the methylthioninium chloride (MC).

Similarly, if a current was detected when the electrical potential between the working electrode (FIG. 5, 524) and the reference electrode (FIG. 5, 526) is approximately 0.35 V, the controller (FIG. 1, 106) would determine the presence of ferrocene (Fe), with the value of the current indicating a particular concentration of ferrocene (Fe). As yet another example, if a current was detected when the electrical potential between the working electrode (FIG. 5, 524) and the reference electrode (FIG. 5, 526) is approximately 0.75 V, the controller (FIG. 1, 106) would determine the presence of erythrosine-based redox label (E), with the value of the current indicating a particular concentration of the erythrosine-based redox label (E). Thus, the present system, using electrochemical responses as indicated in FIG. 6, can determine the presence, and concentration, of fluids in a chamber (FIG. 1, 102).

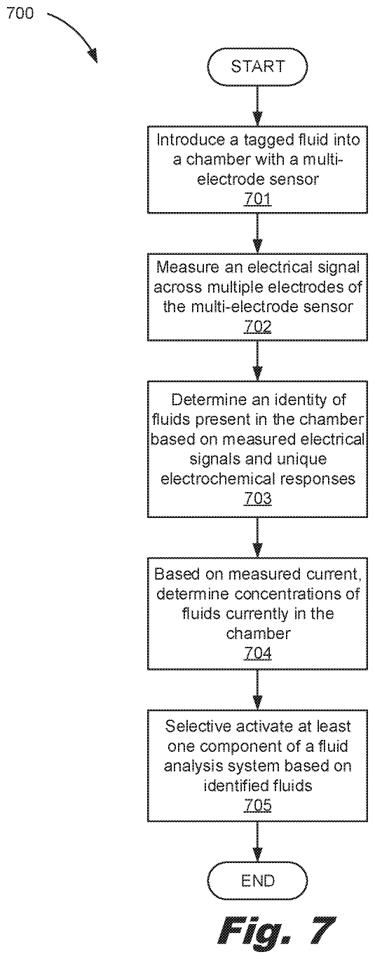

FIG. 7 is a flow chart of a method (700) for fluid identification via electrochemical labels, according to another example of the principles described herein. According to the method (700), a tagged fluid is introduced (block 701) into a chamber (FIG. 1, 102) that includes a multi-electrode sensor (FIG. 1, 104). Electrical signals within the chamber (FIG. 1, 102) are measured (block 702). This may be done as described above in connection with FIG. 4.

Then as described above, based on electrical signals and unique electrochemical responses, an identity of fluids in the chamber (FIG. 1, 102) are determined (block 703). This also may be done as described above in connection with FIG. 4.

In addition to determining the presence of particular fluids, the present method (700) also provides for a determination of the concentration of the detected fluids. For example, based on a measured current value at an electrical potential that is associated with a particular redox label, the controller (FIG. 1, 106) can determine (block 704) the concentration of each fluid currently in the chamber. Based on the fluids detected in the chamber (FIG. 1, 102) as well as their concentrations, the controller (FIG. 1, 106) can selectively activate (block 705) different components to introduce fluids into the chamber (FIG. 1, 102) and/or to expel fluids from the chamber (FIG. 1, 102).

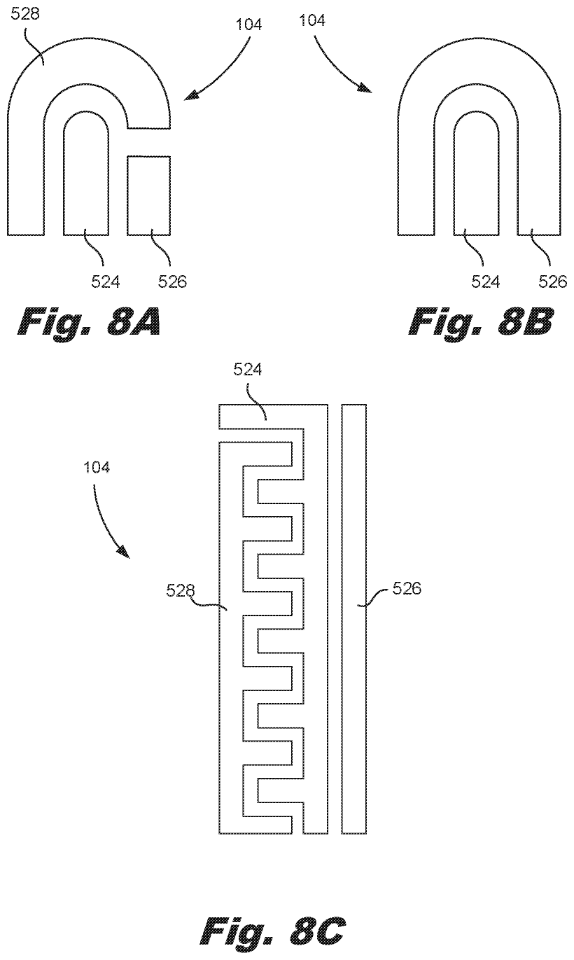

FIGS. 8A-8C depict various multi-electrode sensors (104) for fluid identification, according to an example of the principles described herein. Specifically, FIG. 8A depicts one example of a tri-electrode sensor that includes a working electrode (524), reference electrode (526), and counter electrode (528). In this example, the electrical potential to identify fluids currently in the chamber (FIG. 1, 102) is measured between the working electrode (524) and the reference electrode (526) while the current to determine a concentration of fluids currently in the chamber (FIG. 1, 102) is measured between the working electrode (524) and the counter electrode (528). In some examples, such as depicted in FIG. 8A, the counter electrode (528) may have a larger surface area than the working electrode (524).

FIG. 8B depicts an example where the multi-electrode sensor (106) includes just a reference electrode (526) and a working electrode (524). In this example, the reference electrode (526) acts as a counter electrode (528). That is, a current and electrical potential is measured between the reference electrode (526) and the working electrode (524) to determine a presence and quantity of fluids in the chamber (FIG. 1, 102). Such a two-electrode sensor (106) may operate over a smaller window of electrical potential ranges.

FIG. 8C depicts yet another configuration of a tri-electrode sensor (106) with the respective reference electrode (526), working electrode (524), and counter electrode (528). As described above, each of these multi-electrode sensors (106) may be microfluidic structures. For example, the electrode sensors (106) depicted in FIGS. 8A and 8B may be 250 micrometers by 270 micrometers, or may be even smaller, for example 100 micrometers by 115 micrometers. The multi-electrode sensor (106) depicted in FIG. 8C may be 95 micrometers by 250 micrometers. In some examples, the electrodes of the multi-electrode sensors (104) may be made of particular materials. For example, the reference electrodes (526) may be made out of or silver or silver chloride. The working electrodes (524) can be made of carbon paste, glassy carbon, pyrolytic carbon, porous graphite, doped diamond, metals such as platinum, gold, silver, nickel, mercury, gold amalgam and a variety of alloys, conductive oxides such as indium-tin oxide, zinc-tin oxide and similar materials. The counter electrodes (528) may be less sensitive to material selection and may be made of similar materials as used to form the working electrodes (524).

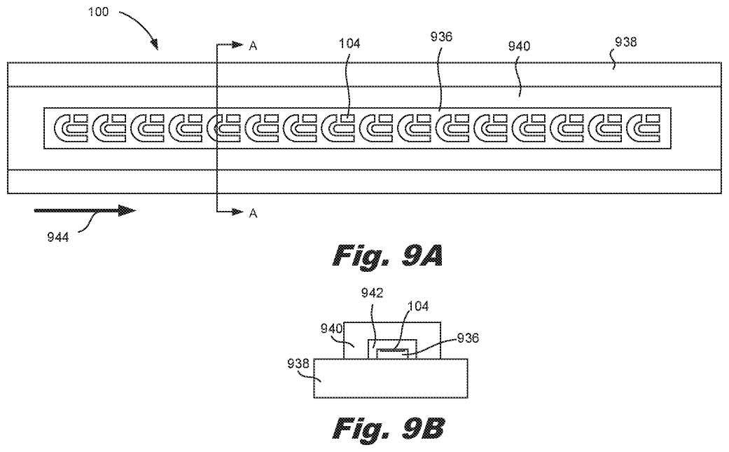

FIGS. 9A and 9B are diagrams of a chamber (FIG. 1, 102) of a fluid analysis device (100) for fluid identification via electrochemical labels, according to an example of the principles described herein. Specifically, FIG. 9A is a top view of the fluid analysis device (100) and FIG. 9B is a cross-sectional view taken along the line A-A from FIG. 9A. As depicted in FIG. 9A, the fluid analysis device (100) may include multiple multi-electrode sensors (104). For simplicity, just one multi-electrode sensor (104) is indicated with a reference number. Multiple multi-electrode sensors (104) may provide redundancy in measurements. That is, if a single multi-electrode sensor (104) is malfunctioning or providing incorrect results, other multi-electrode sensors (104) may account for this malfunctioning multi-electrode sensor (104) by providing additional measurements.

Also, the use of multiple multi-electrode sensors (104) may indicate a fluid gradient and/or concentration gradient across the chamber (FIG. 1, 102). For example, in some cases such as that depicted in FIGS. 9A and 9B, the chamber (FIG. 1, 102) may be a channel (942) through which fluid flows as indicated by the arrow (944). Accordingly, as fluid is flushed in one direction, a concentration of that fluid in the channel (942) may drop nearer the exit of the channel (942). Thus, not only a presence and concentration of a fluid may be detected, but a locality may also be detected. Thus, as described above, more detail can be provided by which a closed-loop control of fluid transport can be carried out.

As depicted in FIG. 9B, the fluid analysis device (100) includes a substrate (938) on which other components of the fluid analysis device (100) are formed. The substrate (938) may be formed of a variety of materials including plastic, silicon, glass, metal, or any other rigid material such as a printed circuit board (PCB).

Disposed on top of the substrate (938) is a die (936), such as a semiconductor die (936). The die (936) provides a mounting surface for the multi-electrode sensors (104) that operate on the fluid. The die (936) also provides electrical routing between the multi-electrode sensors (104) and the controller (FIG. 1, 106).

The fluid analysis device (100) also includes a lid (940) that is adhered to the substrate (938). Formed in the lid (940) is a channel (942). That is, during fabrication a recess is formed in the lid (940). This channel (942) is seated over the die (936). In this way, fluid that passes through the channel (942) is passed over the die (936), thus exposing the fluid to the multi-electrode sensors (104) disposed thereon such that the fluid may be measured. The lid (940) and the substrate (938) may form a microfluidic chamber to hold a volume of at least one fluid. The lid (940) may be formed of any material including glass, plastic, and polycarbonate. In other examples, the lid (940) may be formed of another material such as SUB. In this example, the channel (942) may be fabricated during the manufacturing operation for the die (104).

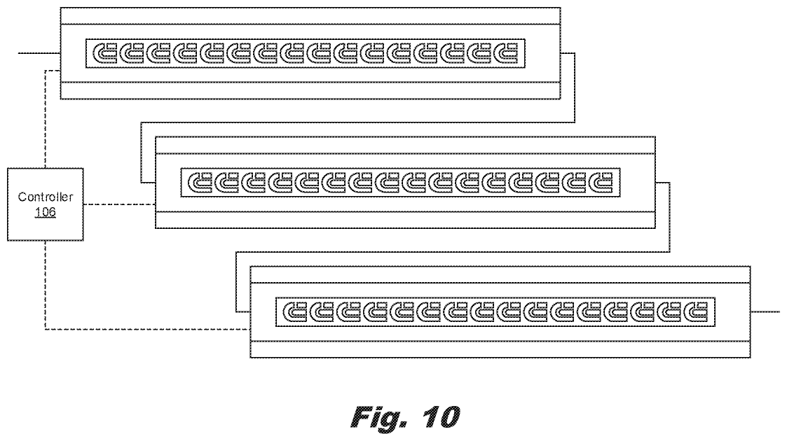

FIG. 10 is a diagram of a fluid analysis system (FIG. 2, 208) for fluid identification via electrochemical labels, according to another example of principles described herein. As described above, in some examples the fluid analysis system (208) includes multiple fluid analysis devices (FIG. 1, 100). In some examples, the controller (106) of each fluid analysis device is a shared controller (106). That is, the controller (106) is coupled to multiple multi-electrode sensors (FIG. 1, 104) disposed in multiple chambers (FIG. 1, 102). In this example, different fluid analysis devices (FIG. 1, 100) may be multiplexed to a single controller (106) with its associated potentiostat (FIG. 3, 320) and control circuit (FIG. 3, 322). In this example, the controller (106) is coupled to multiple chambers (FIG. 1, 102). In some examples, as depicted in FIG. 10, the multiple chambers are coupled in series.

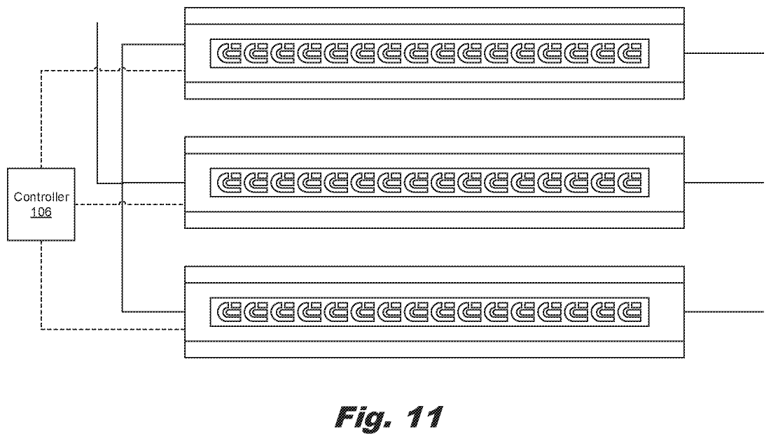

FIG. 11 is a diagram of a fluid analysis system (FIG. 2, 208) for fluid identification via electrochemical labels, according to another example of principles described herein. As described above, in some examples the fluid analysis system (208) includes multiple fluid analysis devices (FIG. 1, 100) having a shared controller (106). In some examples, as depicted in FIG. 11, the multiple chambers are coupled in parallel.

The systems and methods of the present specification 1) provide reliable detection of specific fluids by tagging each with a different electrochemical label which enables fluid traceability; 2) provides information regarding the cleansing of a fluid from the chamber; 3) increases speed of test and cleansing reliability by stopping a cleansing operation when a fluid is no longer detected; 4) provides an indication of a potential source of test failure; 5) prevents cross contamination and undesired mixing of fluids in a chamber; 6) provides feedback as to the concentration of specific fluids in a chamber; 7) provides data regarding combination of different fluids such that sufficient mixing may be determined; 8) provides precise control over which fluid is in the chamber; 9) enables automatic control of fluid delivery; 10) reduces human or system error which may produce undesired fluid delivery and/or cross-contamination; 11) enables efficient use of valuable fluids; and 12) miniaturizes electrochemical monitoring.

What is claimed is:

1. A fluid analysis device, comprising:
a chamber to receive a number of fluids, wherein at least one fluid comprises an electrochemical label with a unique electrochemical response to an applied electrical potential;
a multi-electrode sensor disposed within the chamber to detect electrical signals within the chamber; and
a controller coupled to the multi-electrode sensor to:
apply an electrical potential across multiple electrodes of the multi-electrode sensor; and
identify, from an electrical signal detected by the multi-electrode sensor, fluids currently in the chamber based on the unique electrochemical responses of associated electrochemical labels.

2. The fluid analysis device of claim 1, wherein the controller determines, based on a current within the chamber and the electrochemical responses of associated electrochemical labels, a concentration of fluids currently in the chamber.

3. The fluid analysis device of claim 1, wherein:
the multi-electrode sensor comprises a reference electrode and a working electrode; and
electrical signals within the chamber are measured between the reference electrode and the working electrode.

4. The fluid analysis device of claim 1, wherein:
the multi-electrode sensor comprises a working electrode, a counter electrode, and a reference electrode;
an electrical potential to identify fluids currently in the chamber is measured between the working electrode and the reference electrode; and
a current to determine a concentration of fluids currently in the chamber is measured between the working electrode and the counter electrode.

5. The fluid analysis device of claim 4, wherein the counter electrode has a larger surface area than the working electrode.

6. The fluid analysis device of claim 1, wherein the chamber comprises multiple multi-electrode sensors.

7. A fluid analysis system comprising:
a number of reservoirs, each to hold:
a volume of a redox label having a unique electrochemical response to an applied electrical potential; and
a volume of fluid to be used in a chamber;
a number of chambers to receive a mixture of the fluid and an associated redox label;
a multi-electrode sensor disposed within each chamber to detect electrical signals within the chamber;
a controller coupled to the multi-electrode sensor to:
apply an electrical potential across multiple electrodes of the multi-electrode sensor;
identify, from an electrical signal detected by the multi-electrode sensor, fluids currently in the chamber based on the unique electrochemical responses of associated redox labels; and
measure, from a current detected by the multi-electrode sensor, a concentration of fluids currently in the chamber based on the electrochemical responses of associated redox labels.

8. The fluid analysis system of claim 7, wherein the controller is coupled to multiple multi-electrode sensors in multiple chambers.

9. The fluid analysis system of claim 7, wherein the chambers are coupled in series.

10. The fluid analysis system of claim 7, wherein the chambers are coupled in parallel.

11. A method, comprising:
introducing a tagged fluid into a chamber with a multi-electrode sensor;
measuring an electrical signal across multiple electrodes of the multi-electrode sensor;
identifying, from the electrical signal, fluids currently in the chamber based on the unique electrochemical responses of associated electrochemical labels; and
selectively activating at least one component of a fluid analysis system, which at least one component is coupled to the chamber, based on an identified fluid.

12. The method of claim 11, further comprising:
measuring a current across multiple electrodes of the multi-electrode sensor; and
based on a measured current and the electrochemical responses of associated electrochemical labels, determining concentrations of fluids currently in the chamber.

13. The method of claim 11, wherein the at least one component comprises a component selected from the group consisting of:
a valve; and
a pump.

14. The method of claim 11, wherein selectively activating at least one component of the fluid analysis system comprises independently opening a number of valves to draw quantities of a first fluid and a second fluid into the chamber until a predetermined ratio of the first fluid and the second fluid is detected in the chamber based on unique electrochemical responses of electrochemical labels associated with the first fluid and the second fluid.

15. The method of claim 11, wherein selectively activating at least one component of the fluid analysis system comprises activating a fluid pump to draw fluid out of the chamber until it is detected that less than a threshold quantity of the fluid remains in the chamber.
